(19) United States
(12) Patent Application Publication
(10) Pub. No.: US 2004/0103658 A1
(43) Pub. Date: Jun. 3, 2004

(54) Fluid wave electric generator system

(76) Inventor: Manny Oscar Laveria, Carson City, NV (US)

Correspondence Address: MANNY LAVERIA, 2131 CLEARVIEW DR., CARSON CITY, NV, 89701, US

(21) Appl. No.: 10/307,569

(22) Filed: Dec. 2, 2002

(51) Int. Cl. F03C 1/00

(52) U.S. Cl. 60/495

(57) ABSTRACT

There is thus provided, in accordance with a preferred embodiment of the invention, a system for conversion of wave energy in a body of a fluid using electromagnetic coupling (by moving a magnetic device inside a coil, or a coil inside magnetic field) driven by the linear motion due to either a buoy on a liquid or a linear movement induced by any mechanical means driven by a fluid, including: (a) a stationary support element mounted to the floor or to the floor of the body of the fluid in the form of a magnet or a coil; (b) a moving or buoyancy apparatus, for liquid fluids, including a buoy portion having formed therewith wave energy collection apparatus in the form of a floating device containing a magnet, or a coil; (c) coupling apparatus for connecting the moving or buoyancy apparatus to the stationary support element so as to be pivotal in a generally vertical plane with respect to the stationary support element; (d) at least a set a cables to allow for the flow of the electric current to a control/regulator/storage device, correspondingly, the piston apparatus being guided by a stationary support, in association with a predetermined element operative to move in response to movement of the moving or buoyancy apparatus, or running fluid such as air or running water.

### FIELD OF THE INVENTION

The present invention relates to the utilization of kinetic energy from liquid waves and fluid currents and particularly to a electromagnetic apparatus for converting this energy to consumable electric energy, or any non liquid fluid such as air, which will produce a circular motion, motion that in turn will be linearized to a one-axis movement.

### BACKGROUND OF THE INVENTION

The utilization of the energy produced by the flow of sea waves, or air, has been the subject of numerous and varied proposals. Apparatus has been proposed, both of the floating type and of the type anchored to the sea floor and which convert the wave energy into storable form. Also known are floating buoys or bladders, which oscillate vertically, in accordance with forces produced by the waves. Air driven systems are being used to drive generators directly.

Floating members are particularly suited for the exploitation of gravitational forces induced by the rise and fall of the waves, while static structures are suited more for conversion of a vertical movement of water, into electricity. It will thus be appreciated that each type of device is suited specifically for exploitation of one of the forms of energy produced by the motion of waves and currents, to the exclusion of the other.

Attempts to convert top electricity generally single axis wave forces, generated by the rise and fall of flotation bladders, or air driven, have been made using these forces to rotate in order to activate a generator. These gears are connected either to the flotation bladders and to a hydraulic pump that discharges fluid into an accumulator when activated, which then delivers fluid so as to operate a suitable type of electrical power plant, or are directly connected to an electrical generator.

One disadvantage of such apparatus that relies on floating members is that the amount of sea wave energy that may be absorbed thereby is dependent on the location of the member in relation to a tide level. Furthermore, some devices include elements that either must be fastened to a stable surface. This renders such devices expensive to manufacture and/or to maintain.

Various solutions have been suggested, like the use of wave transducers connected to computers in order to accurately control the movement of the floating members. These solutions have the disadvantage of requiring sophisticated electronic equipment. Apparatus, which are situated away from the shore, require expensive equipment in order to convert the wave energy to an energy form, which is easily transferable.

### SUMMARY OF THE INVENTION

The present invention seeks to provide a very efficient and inexpensive system and method of converting energy produced by a fluid like wind, vapor, water or sea waves into electricity.

There is thus provided, in accordance with a preferred embodiment of the invention, a system for conversion of wave energy in a body of water or any fluid having a floor, including:

(a) a stationary support element rigidly mounted to the floor or to the body of the fluid/water—this could be attached to land, or to a floating device, much bigger than the coupled floating device. This is done to enhance the differential movement between the stationary element and the floating part of the device. The pair of the moving apparatus and the stationary support is called a cell.

(b) buoyancy apparatus including a buoy portion having formed therewith wave energy collection apparatus in the form of a magnet/s or a coil/s coupled to a coil/s or a magnet/s respectively.

(c) coupling apparatus for vertically connecting the moving or buoyancy apparatus to the stationary support element so as to be pivotal in a generally vertical plane with respect to the stationary support element; it is understood that in case the stationary support element is also a floating device, this vertical movement will not be parallel to the force of gravity but vertical between the stationary device and the buoyancy device giving the floating device freedom of movement in one axis with respect to the stationary device.

(d) at least one electromagnetic apparatus for electrical current generation per cell when the piston apparatus is moved up or down along the cell's axis, correspondingly, the piston apparatus being held at least to one end to the stationary support, in association with a predetermined element operative to move in response to movement of the moving or buoyancy apparatus.

(e) a device to regulate, control and store the generated electric current.

Further in accordance with the present invention, the number of coupling devices per cell can be of more than one, limited only by the electromechanical resistance to the mechanical movement.

Additionally in accordance with the present invention, the buoyancy apparatus is formed so as to define a wave diversion surface extending above the opening so the fluid (i.e. water) can be expelled, should it be required, over the device.

In accordance with an alternative embodiment of the invention, there is provided a system for conversion of wave energy in a body of water having a floor, including:

(a) a stationary support element rigidly mounted to the floor of the body of water or resting on the body of water; the element is rigid as it has no moving parts. It is rigid compared to the moving element which is free to move on one axis;

(b) a moving or buoyancy apparatus including a free moving or buoy portion having formed therewith wave energy collection apparatus in the form of a piston integrally formed therewith;

(c) coupling apparatus for connecting the moving or buoyancy apparatus to the stationary support element wherein the moving or buoyancy apparatus is pivotal in a vertical plane with respect to a predetermined axis in the stationary support element, the coupling apparatus include at least two parallel support arms, each of which is hinged to the stationary element and to the moving or buoyancy apparatus, wherein each support arm is pivotal in a vertical plane about the stationary support element and the buoyancy apparatus, wherein corresponding portions of each support arm between its hinges are of equal length, and wherein the moving or buoyancy apparatus is free to move along at least a portion of a circular path described with respect to the stationary support element, in a generally vertical plane, while the moving or buoy portion is retained above the collection apparatus,

and wherein at least one of the support arms includes a counterbalancing weight extending from the central axis toward the side opposed to the moving or buoyancy apparatus;

a device to capture running fluids (air or water) like a propeller, paddles, fan or any other device to be connected to a mechanical adapter to convert a running fluid into the linear movement required by the electromagnetic generator

a device to convert rotational movement into linear movement by means of gears, cams, pulleys etc.

### DETAILED DESCRIPTION OF THE INVENTION

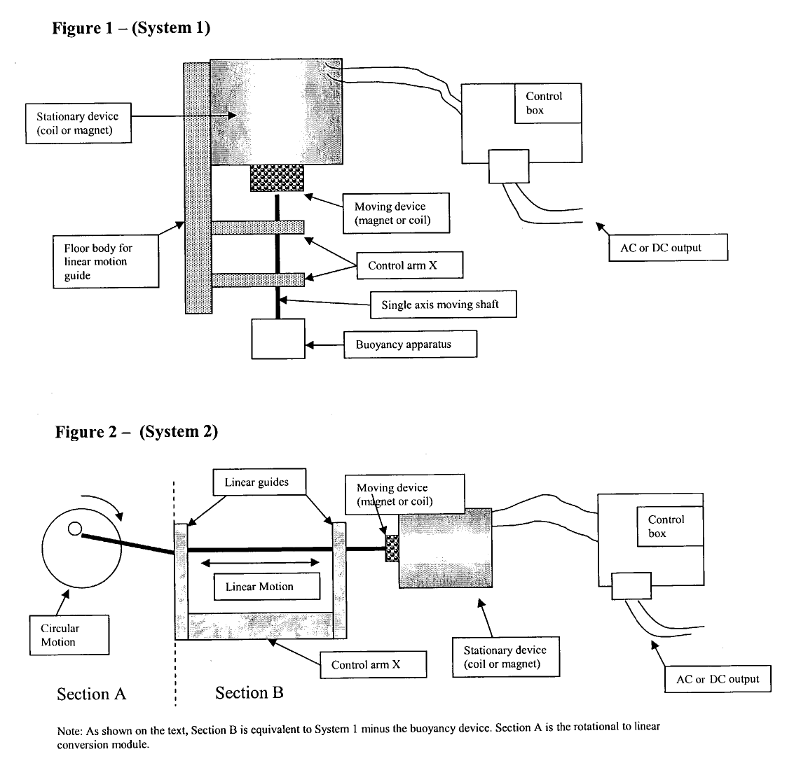

Referring to FIG. 1, there are shown, in schematic form, the main components of the fluid wave energy conversion system, generally denoted System 1. System 1 may be installed in substantially any body of fluid having a floor and a fluid flow. Preferably, but not limited to, System 1 is employed for the utilization of sea wave, and System 2 is employed for the utilization of running fluids like water, vapor or air (wind). These would be collected by a propeller or a paddle, which in turn would convert rotary motion into linear motion in which case the wave electric generating device could be applied through a connecting device.

System 1 includes a stationary support element rigidly mounted to a floor. It will be appreciated that the proportions of all the elements of system 1 in general, and of the stationary element in particular are by way of example only, and may vary substantially in practice depending on the application and the amount of current required. For example, the height and width of stationary support element may be much larger if System 1 is installed in high seas. System 1 is operative to harness wave energy by buoyancy apparatus, for example if used on water, it is adapted to float on the water. Preferably, buoyancy apparatus is attached to support element as by suitable coupling apparatus, and includes a buoy portion, formed with a wave energy collection apparatus. System two is the complement of System 1 and adapts the device for use with running fluids.

As described, buoyancy apparatus is attached to stationary support element by means of a coupling apparatus —which is illustrated herein as a plain rod, via which buoyancy apparatus is supported so as to pivot in a generally vertical plane about an axis in stationary element. This ensures the effective coupling of the magnet to the coil, in fact inducing an electrical current on it.

While coupling apparatus may have a very simple construction, the illustrated construction in FIG. 2 shows coupling apparatus as having at least one support arm, which is connected to stationary support element. It is clear that more than one of the illustrated support arm may also be provided.

The buoyancy apparatus can be under, in or over the stationary device in a vertical plane intersecting with stationary support element. Optionally, the linear movement of the buoyancy apparatus and the support arms may be constructed so as to limit the movement of the buoyancy apparatus in respect of stationary support element, and therefore to limit the buoyancy apparatus' movement along a predetermined length. Considerations such as structural strength and the ratio between the average wave height and the linear motion will account for the construction of a system in accordance with the present invention.

On the buoyancy-based model (System 1), it will thus be appreciated that when a wave encounters buoyancy apparatus, it floats and rises upwards due to its lighter weight, and comes down due to gravity. The buoyancy apparatus has freedom on one axis, so the movement is vertical to the stationary device and proportional to the liquid movement.

It will be appreciated that, on the running fluid operated model (System 2), since the moving apparatus moves linearly following the motion of the circular propeller, from this point on, the system is equivalent to the buoyancy based system.

### BRIEF DESCRIPTION OF THE DRAWING

The present invention will be further understood and appreciated from the following detailed description, taken in conjunction with the following enclosed drawing denoted FIG. 1.

a) FIG. 1 illustrates in a schematic diagram the proposed system for conversion of wave energy from a fluid (air or liquid) to consumable power according to a preferred embodiment of the present invention for a buoyancy mode (System 1).

b) FIG. 2 illustrates the second option (System 2) when a rotational device such as a propeller replaces a buoyancy element or a paddle for applications on air, running water or vapor, by means of a cam, gears, pulleys etc.

1. What I claim as my invention is a system for conversion of fluid kinetic energy (such as sea waves) into electricity using electromagnetic coupling, including: (a) a stationary support element mounted to the floor or to the floor of the body of the fluid in the form of a magnet or a coil; (b) a moving or buoyancy apparatus, in case the fluid is liquid, including a buoy portion having formed therewith wave energy collection apparatus in the form of a floating device containing a magnet, or a coil; (c) coupling apparatus for connecting the moving or buoyancy apparatus to the stationary support element so as to be pivotal in a generally vertical plane with respect to the stationary support element; (d) at least a set a cables to allow for the flow of the electro magnetically generated current to a control/regulator/storage device, correspondingly, the piston apparatus being guided by a stationary support, in association with a predetermined element operative to move in response to movement of the moving or buoyancy apparatus; (e) a system formed by the addition in parallel or series to increase the system capacity to convert wave energy from a fluid into electricity.

2. The system as claimed in claim I, wherein said coupling apparatus include at least one support arm, each of which is hinged to said stationary support element and to said moving or buoyancy apparatus, wherein each support arm is pivotal with respect to said stationary support element and said buoyancy apparatus in a generally vertical plane to the stationary apparatus, and wherein said moving buoyancy apparatus is free to move along vertically described with respect to said stationary support element, in a generally vertical plane, while said buoy portion is retained above, inside or under said collection apparatus.

3. The system as claimed in claim I, wherein said current generation is performed by electromagnetic coupling driven by a fluid converting linear fluid movement into ondulating or pulsating movement. Being that the magnet or electromagnet can be the stationary device and the coil the one on the moving device or the magnet can be on the moving device and the coil on the stationary device.

4. The system as claimed in claim I, wherein said buoyancy or moving apparatus is formed so as to define electromagnetic generation of current by inducing an electromagnetic field from the magnet into the coil driven by the linear motion caused by the oscillation of the moving apparatus.

5. A system for conversion of wave energy in a body of water having a floor, including: (a) a stationary support element rigidly mounted to the floor of a body; (b) linear moving or buoyancy apparatus including a buoy portion having formed therewith wave energy collection apparatus in the form of a cavity integrally formed therewith; (c) coupling apparatus for connecting said moving or buoyancy apparatus to said stationary support element wherein said moving or buoyancy apparatus is pivotal in a vertical plane with respect to a predetermined axis in said stationary support element, said coupling apparatus include at least one support arm, connected to said stationary element, wherein the support arm is pivotal in a vertical plane about said stationary support element and said buoyancy apparatus, and wherein said buoyancy apparatus is free to move along at least a portion of a vertical path described with respect to said stationary support element, in a generally vertical plane, while said buoy portion is retained above, in between, under or in any way mechanically connected to the said collection apparatus; (d) at least one magnet or coil for generating a electromagnetic field when said piston apparatus is moved up or down according to the movement of the waves, correspondingly, said piston apparatus being held at one end to a stationary support, in association with a predetermined element operative to move in response to movement of said buoyancy apparatus.

6. The system as claimed in claim I, wherein the electro magnetically generated electricity is regulated, controlled and stored. Control is achieved by electronic means so the variable current and voltage can be harnessed, stabilized and regulated.

7. The system is called a cell. Each cell has at least one coil and one magnetic device and could have more limited only by mechanical or electromechanical resistance or weight.

8. The system can be added to conform multiple cells in order to increase the conversion of energy.

9. The output of the system can be of AC or DC nature depending on the application. It can also be connected to a storage device such as rechargeable batteries.
